(19) United States
(12) Patent Application Publication
(10) Pub. No.: US 2014/0096353 A1
(43) Pub. Date: Apr. 10, 2014

(54) CROSSBAR, AND SYSTEM AND METHOD OF REPLACING A CROSSBAR

(71) Applicant: AIDA ENGINEERING, LTD., Sagamihara-shi (JP)

(72) Inventor: Toshihiro OJIMA, Sagamihara-shi (JP)

(73) Assignee: AIDA ENGINEERING, LTD., Sagamihara-shi (JP)

(21) Appl. No.: 14/048,007

(22) Filed: Oct. 7, 2013

(30) Foreign Application Priority Data
Oct. 10, 2012 (JP) 2012-225410

(51) Int. Cl. B30B 15/00; B25J 15/00

(52) U.S. Cl. CPC B30B 15/00; B25J 15/00
USPC 29/426.2; 294/81.1; 29/823

(57) ABSTRACT

Provided is a system for replacing a crossbar, which is capable of promptly and smoothly mounting and removing a crossbar for replacement between a workpiece transferring apparatus and a crossbar replacing apparatus. The crossbar is to be mounted to the workpiece transferring apparatus. The crossbar extends substantially orthogonal to a workpiece transferring direction in a press machine and is configured to be capable of retaining and releasing a workpiece. The crossbar is configured to be switchable between a state in which both end portions of the crossbar are rotatable relative to a center portion of the crossbar about a longitudinal axis of the crossbar, and a state in which both the end portions are not rotatable relative to the center portion.

### BACKGROUND OF THE INVENTION

1. Field of the Invention

The present invention relates to a technology for replacing, in accordance with a type of a workpiece or the like, a crossbar with respect to, for example, a workpiece transferring apparatus that transfers a workpiece by supporting the workpiece by a crossbar that extends substantially orthogonal to a workpiece transferring direction between press machines (pressing machines).

2. Background

An example of a conventional tool replacing device (crossbar replacing apparatus) is described in, for example, Japanese Patent Application Laid-open No. 2011-50995.

A crossbar replacing method described in Japanese Patent Application Laid-open No. 2011-50995 is based on the premise that a workpiece transferring apparatus that uses a crossbar includes a rotational drive mechanism in a part that supports the crossbar, and that the workpiece transferring apparatus has such a tilting function that, by rotating the crossbar, an arm part or the like that supports the workpiece can be arbitrarily tilted (pivoted).

Further, in the method described in Japanese Patent Application Laid-open No. 2011-50995, when replacing the crossbar, an operation of tilting (pivoting) the crossbar by a predetermined degree via a tilting mechanism is required so that, as a result, the arm portion that supports the workpiece is tilted.

In this case, as described above, the workpiece transferring apparatus can transfer workpieces in various shapes by replacing the crossbar.

For example, it is assumed a case where processing of workpieces having different shapes is necessary every hour. In such a case, the crossbar is changed so as to correspond to the shape of the workpiece. In order to reduce the downtime of the production line as much as possible and increase the production efficiency, it is required to promptly switch between current production and subsequent production without delay.

Therefore, during current production, it is necessary to prepare a crossbar for subsequent production (crossbar to be used for subsequent production). Therefore, during current production, the crossbar replacing apparatus is retreated outside the production line, and when replacing the crossbar, the crossbar replacing apparatus supporting the crossbar for subsequent production is moved toward the vicinity of the workpiece transferring apparatus.

At this time, the crossbar replacing apparatus passes through a gap present between press machines installed on the upstream and the downstream in a press work process of the workpiece transferring apparatus. In a case where, as illustrated in FIG. 7A, a crossbar 1100 is in the same horizontal attitude as that during production, the size of the crossbar 1100 including a tool 1105 is larger than the gap between press machines 1 and 2. Therefore, the crossbar 1100 may interfere with the press machines 1 and 2 on the upstream and the downstream in the press work process.

In view of this, conventionally, the following method is adopted to avoid interference. As illustrated in FIG. 7B, with use of tilting functions (rotational drive portions) of the workpiece transferring apparatus (see reference symbol 1315 of FIG. 6A etc.), under a state in which the entire crossbar 1100 is tilted (rotated), the crossbar 1100 is stacked on a crossbar replacing apparatus 1200.

In this case, in order to simplify the description, description is made of a case where the crossbar is stacked on the crossbar replacing apparatus in an attitude tilted by about 90° with respect to a vertical direction.

An example of an operation when the workpiece transferring apparatus stacks (passes) the crossbar 1100 for current production (crossbar 1100 that has been used for current production) onto the crossbar replacing apparatus 1200 is described (in the order of FIGS. 6F, 6E, 6D, 6C, 6B, and 6A).

In Step 101, a workpiece transferring apparatus 1300 uses a drive force of the tiling functions (rotational drive portions) 1315 to rotate crossbar mounting and removing portions 1320 at respective leading ends of swing arms 1310 so that the crossbar 1100 for current production is tilted by about 90° with respect to the vertical direction (operation from FIG. 6F to FIG. 6E).

In Step 102, while maintaining the attitude tilted by 90°, the crossbar 1100 for current production is lowered, stacked, and fixed onto a crossbar tray 1210 on the upper surface of the crossbar replacing apparatus 1200 (operation from FIG. 6E to FIG. 6D).

In Step 103, while maintaining fixation of the crossbar 1100 for current production to the crossbar replacing apparatus 1200, the crossbar mounting and removing portions 1320 provided at the leading ends of the swing arms 1310 of the workpiece transferring apparatus 1300 are separated in a horizontal direction (operation from FIG. 6D to FIG. 6C).

Next, an example of an operation when the workpiece transferring apparatus removes the crossbar 1100 for subsequent production from the crossbar replacing apparatus 1200 supporting the crossbar 1100 for subsequent production to mount (receive) the crossbar 1100 for subsequent production is described (in the order of FIGS. 6A, 6B, 6C, 6D, 6E, and 6F).

In Step 111, under a state in which a crossbar is not mounted, the workpiece transferring apparatus 1300 is caused to approach the crossbar replacing apparatus 1200 supporting the crossbar 1100 for subsequent production (operation from FIG. 6A to FIG. 6B), and crossbar fitting surfaces 1321 of the crossbar mounting and removing portions 1320 at the respective leading ends of the swing arms 1310 are tilted by about 90° with respect to the vertical direction (operation from FIG. 6B to FIG. 6C).

In Step 112, the crossbar mounting and removing portions 1320 tilted by 90° are, in the horizontal direction, brought into close contact and mounted to mounting and removing devices 1130 provided at both end portions of the crossbar 1100 for subsequent production similarly tilted by 90° (operation from FIG. 6C to FIG. 6D). As the mounting, such a method that uses guide pins for guiding and a latch mechanism or the like for engagement and retention can be adopted.

In Step 113, while maintaining the attitude tilted by 90°, the workpiece transferring apparatus 1300 raises the crossbar 1100 for subsequent production in a vertically upward direction to remove the crossbar 1100 for subsequent production from the crossbar replacing apparatus 1200 (operation from FIG. 6D to FIG. 6E).

In Step 114, the drive force of the tilting functions (rotational drive portions) 1315 of the workpiece transferring apparatus 1300 is used to rotate the crossbar mounting and removing portions 1320. While rotating the crossbar 1100 for subsequent production in a 90°-tilted state into a horizontal state that adapts to production, the workpiece transferring apparatus 1300 returns to a defined position to prepare for subsequent production (operation from FIG. 6E to FIG. 6F).

The conventional crossbar replacing method described above is excellent in terms of simplicity of the crossbar structure.

However, in the conventional crossbar replacing method, the crossbar 1100 is placed on (supported by) the crossbar replacing apparatus 1200 in such an attitude that fitting surfaces 1131 of the mounting and removing devices 1130 provided at both end portions 1120 thereof are erected in a substantially vertical direction.

Therefore, when the workpiece transferring apparatus 1300 moves to pick up the crossbar 1100, it is necessary to bring the crossbar fitting surfaces 1321 of the crossbar mounting and removing portions 1320 into close contact with the fitting surfaces 1131 in the horizontal direction while substantially vertically erecting the crossbar fitting surfaces 1321. Therefore, in the workpiece transferring apparatus 1300 including the swing arms 1310, there remains a problem in that operation control, operation and adjustment (setup), and the like are difficult.

That is, when the crossbar mounting and removing portions 1320 are mounted to the mounting and removing devices 1130 while substantially vertically erecting the crossbar fitting surfaces 1321 of the crossbar mounting and removing portions 1320, guide pins 322 illustrated in FIG. 9 are protruded in the horizontal direction. Therefore, the following difficult operation is necessary. That is, by combining a swinging operation of the swing arms 1310, an extending and contracting operation of the swing arms 1310, and a rotating operation (tilting operation) of the crossbar mounting and removing portions 1320 by the tilting functions (rotational drive portions) 1315, the workpiece transferring apparatus 1300 causes the crossbar fitting surfaces 1321 of the crossbar mounting and removing portions 1320 to horizontally move while substantially vertically erecting the crossbar fitting surfaces 1321, to thereby smoothly engage the mounting and removing devices 1130 with the guide pins 322 extending in the horizontal direction for mounting.

In addition, the following actual situation is known. That is, when the mounting and removing devices 1130 and the guide pins 322 are engaged with each other, even in a case where the guide pins 322 are desired to be moved slightly downward, the crossbar 1100 placed on (supported in the gravity direction by) the crossbar replacing apparatus 1200 cannot be moved downward any more. Therefore, careful horizontal movement at extremely high accuracy is required for the workpiece transferring apparatus 1300 and the crossbar mounting and removing portions 1320.

### SUMMARY OF THE INVENTION

The present invention has been made in view of such a conventional actual situation, and has an object to provide a structure of a crossbar and a system and method of replacing a crossbar, which are capable of, even with a relatively simple and low-cost configuration, promptly and smoothly mounting and removing a crossbar supported by a workpiece transferring apparatus and replacing the crossbar between the workpiece transferring apparatus and a crossbar replacing apparatus, and thus capable of reducing the setup operation time period to improve the production efficiency or the like.

Therefore, according to one embodiment of the present invention, there is provided a crossbar, which is to be mounted to a workpiece transferring apparatus and is configured to be capable of retaining and releasing a workpiece, the crossbar extending substantially orthogonal to a workpiece transferring direction in a press machine,

the crossbar being configured to be switchable between a state in which both end portions of the crossbar are rotatable relative to a center portion of the crossbar about a longitudinal axis of the crossbar, and a state in which both the end portions are not rotatable relative to the center portion.

Further, according to one embodiment of the present invention, there is provided a system for replacing a crossbar, the system including:

a crossbar that extends substantially orthogonal to a workpiece transferring direction in a press machine and is configured to be capable of retaining and releasing a workpiece;

a workpiece transferring apparatus that transfers the workpiece with use of the crossbar; and

a crossbar replacing apparatus that is configured to be capable of supporting the crossbar,
the crossbar being replaced between the workpiece transferring apparatus and the crossbar replacing apparatus,

the system being configured to:
use the crossbar configured to be switchable between a state in which both end portions of the crossbar are rotatable relative to a center portion of the crossbar about a longitudinal axis of the crossbar, and a state in which both the end portions are not rotatable relative to the center portion;
apply, when the workpiece transferring apparatus is moved toward the crossbar replacing apparatus to place the crossbar thereon, a rotation angle phase difference between the center portion and each of both the end portions of the crossbar, to thereby allow the crossbar replacing apparatus to support the crossbar under a state in which a fitting surface of amounting and removing device provided at the each of both the end portions of the crossbar, the fitting surface being removably mountable to a crossbar fitting surface of a crossbar mounting and removing portion of the workpiece transferring apparatus, is oriented in a substantially horizontal direction; and
cause, when the workpiece transferring apparatus is moved toward the crossbar replacing apparatus to pick up the crossbar therefrom, the crossbar fitting surface of the crossbar mounting and removing portion to approach the fitting surface of the mounting and removing device of the crossbar supported by the crossbar replacing apparatus under a state in which the crossbar fitting surface is oriented in the substantially horizontal direction, mount the crossbar to the workpiece transferring apparatus, and then cancel the rotation angle phase difference between the center portion and the each of both the end portions of the crossbar.

In the system for replacing a crossbar according to one embodiment of the present invention, the crossbar supported by the crossbar replacing apparatus may have a workpiece retaining surface oriented in a substantially vertical direction.

Further, according to one embodiment of the present invention, there is provided a method of replacing a crossbar, which extends substantially orthogonal to a workpiece transferring direction in a press machine and is configured to be capable of retaining and releasing a workpiece, between a workpiece transferring apparatus that transfers the workpiece with use of the crossbar and a crossbar replacing apparatus that is configured to be capable of supporting the crossbar,

the method including:

using the crossbar configured to be switchable between a state in which both end portions of the crossbar are rotatable relative to a center portion of the crossbar about a longitudinal axis of the crossbar, and a state in which both the end portions are not rotatable relative to the center portion;

applying, when the workpiece transferring apparatus is moved toward the crossbar replacing apparatus to place the crossbar thereon, a rotation angle phase difference between the center portion and each of both the end portions of the crossbar, to thereby allow the crossbar replacing apparatus to support the crossbar under a state in which a fitting surface of a mounting and removing device provided at the each of both the end portions of the crossbar, the fitting surface being removably mountable to a crossbar fitting surface of a crossbar mounting and removing portion of the workpiece transferring apparatus, is oriented in a substantially horizontal direction; and

causing, when the workpiece transferring apparatus is moved toward the crossbar replacing apparatus to pick up the crossbar therefrom, the crossbar fitting surface of the crossbar mounting and removing portion to approach the fitting surface of the mounting and removing device of the crossbar supported by the crossbar replacing apparatus under a state in which the crossbar fitting surface is oriented in the substantially horizontal direction, mounting the crossbar to the workpiece transferring apparatus, and then canceling the rotation angle phase difference between the center portion and the each of both the end portions of the crossbar.

In the method of replacing a crossbar according to one embodiment of the present invention, the crossbar supported by the crossbar replacing apparatus may have a workpiece retaining surface oriented in a substantially vertical direction.

According to one embodiment of the present invention, it is possible to provide the structure of the crossbar and the system and method of replacing a crossbar, which are capable of, even with a relatively simple and low-cost configuration, promptly and smoothly mounting and removing the crossbar supported by the workpiece transferring apparatus and replacing the crossbar between the workpiece transferring apparatus and the crossbar replacing apparatus, and thus capable of reducing the setup operation time period to improve the production efficiency or the like.

In particular, according to the structure of the crossbar and the system and method of replacing a crossbar according to one embodiment of the present invention, it is possible to prevent the workpiece transferring apparatus from mounting and removing the crossbar in a substantially horizontal direction. Therefore, when replacing the crossbar, it is unnecessary to adjust the tilting angle of the mounting and removing devices on the workpiece transferring apparatus side and on the crossbar side. Therefore, the replacing operation becomes easier and faster, and thus the setup operation time period may be reduced to improve the production efficiency or the like.

### BRIEF DESCRIPTION OF THE DRAWINGS

In the accompanying drawings:

FIG. 1 is an overall configuration view (view as seen from a workpiece transferring direction) schematically illustrating an overall configuration of a workpiece transferring apparatus and a crossbar replacing apparatus of a press machine according to an embodiment of the present invention;

FIGS. 2A and 2B are views illustrating the crossbar replacing apparatus according to the embodiment of the present invention under a state in which a crossbar is stacked;

FIGS. 3A and 3B are views illustrating a crossbar replacing apparatus in a conventional apparatus under a state in which a crossbar is stacked;

FIG. 4 is a sectional view of a configuration example of the crossbar according to the embodiment of the present invention, which illustrates an example of a rotation mechanism including a free rotation shaft and a rotation fixing mechanism for fixing the rotation, which are provided between a center portion and each of both end portions of the crossbar;

FIGS. 5A to 5G are views illustrating, in the order of FIGS. 5A to 5G, a situation of an operation in which the workpiece transferring apparatus receives the crossbar placed on the crossbar replacing apparatus and separates from the crossbar replacing apparatus, and illustrating, in the order of FIGS. 5G to 5A, a situation of an operation in which the workpiece transferring apparatus supporting the crossbar places the crossbar on the crossbar replacing apparatus and separates from the crossbar replacing apparatus;

FIGS. 6A to 6F are views relating to the conventional apparatus, which illustrate, in the order of FIGS. 6A to 6F, a situation of an operation in which the workpiece transferring apparatus receives the crossbar placed on the crossbar replacing apparatus, and illustrate, in the order of FIGS. 6F to 6A, a situation of an operation in which the workpiece transferring apparatus supporting the crossbar places the crossbar on the crossbar replacing apparatus and separates from the crossbar replacing apparatus;

FIG. 7A is a view (view as seen from the lateral side in the workpiece transferring direction) illustrating a situation where, under a state in which a tool is in the same horizontal attitude as that during production, when the crossbar replacing apparatus travels (moves) between press machines installed on the upstream and the downstream in a press work process for entrance into and retreat from a production line, the tool interferes with the press machines, and FIG. 7B is a view (view as seen from the lateral side in the workpiece transferring direction) illustrating a situation where, by tilting the tool (rotation angle phase difference of 90°), the interference with the press machines is avoided;

FIG. 8 is a sectional view relating to the embodiment of the present invention, which illustrates a situation where the center portion of the crossbar is placed on a crossbar tray mounted on an upper surface of the crossbar replacing apparatus, to thereby fix the rotation of the center portion of the crossbar; and

FIG. 9 is a view relating to the embodiment of the present invention, which illustrates a configuration example of a crossbar mounting and removing portion of the workpiece transferring apparatus, which is mounted to and removed from a mounting and removing device of the crossbar.

### DETAILED DESCRIPTION OF THE PREFERRED EMBODIMENT

In the following, an embodiment of the present invention describing an example of a system and method of replacing a crossbar that is removably mounted to a workpiece transferring apparatus for a pressing machine (press machine) is described with reference to the accompanying drawings. Note that, the present invention is not limited to the embodiment described below.

The workpiece transferring apparatus according to this embodiment is used for, for example, transferring a workpiece W between press machines.

Note that, as the workpiece transferring apparatus according to this embodiment, for example, a swing-arm type workpiece transferring apparatus, which transfers a workpiece by swinging swing arms installed on pillars or the like provided between the press machines, is applicable.

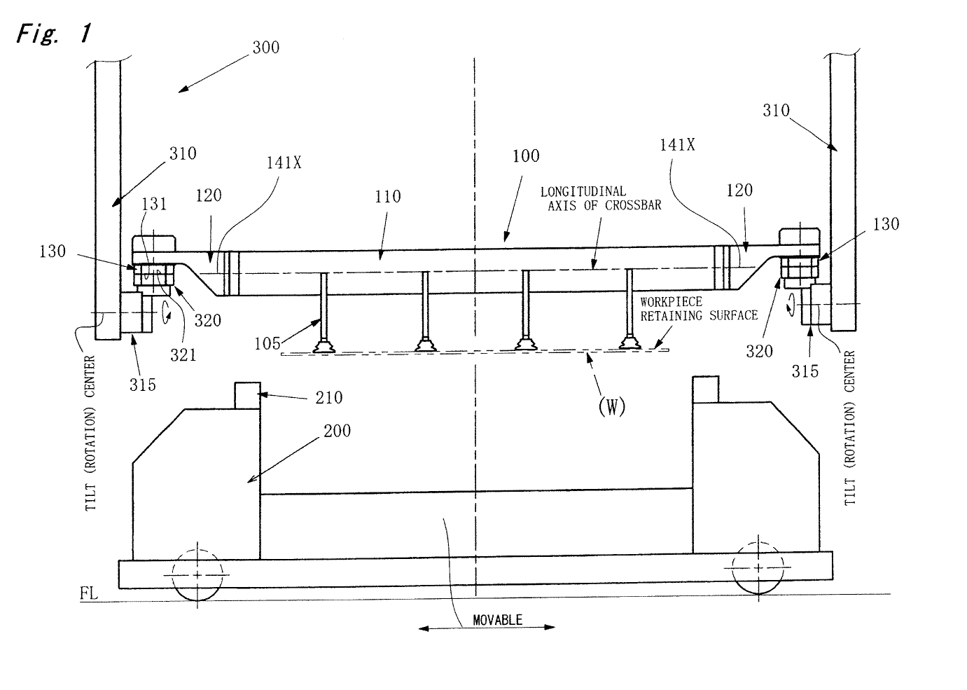

FIG. 1 illustrates a situation where both end portions 120 of a crossbar 100 are mounted on (supported by) a workpiece transferring apparatus 300 through intermediation of crossbar mounting and removing portions 320, and illustrates a crossbar replacing apparatus 200 capable of stacking (placing, supporting) the crossbar 100. FIG. 1 illustrates a workpiece W in a state (imaginary line) of being attracted and supported by a tool 105. Note that, a surface formed by a workpiece retaining portion of the tool 105 (surface parallel to the surface of the workpiece W) is referred to as “workpiece retaining surface”.

The crossbar replacing apparatus 200 can be constructed of a wagon or a robot that is capable of self-propelling or moving.

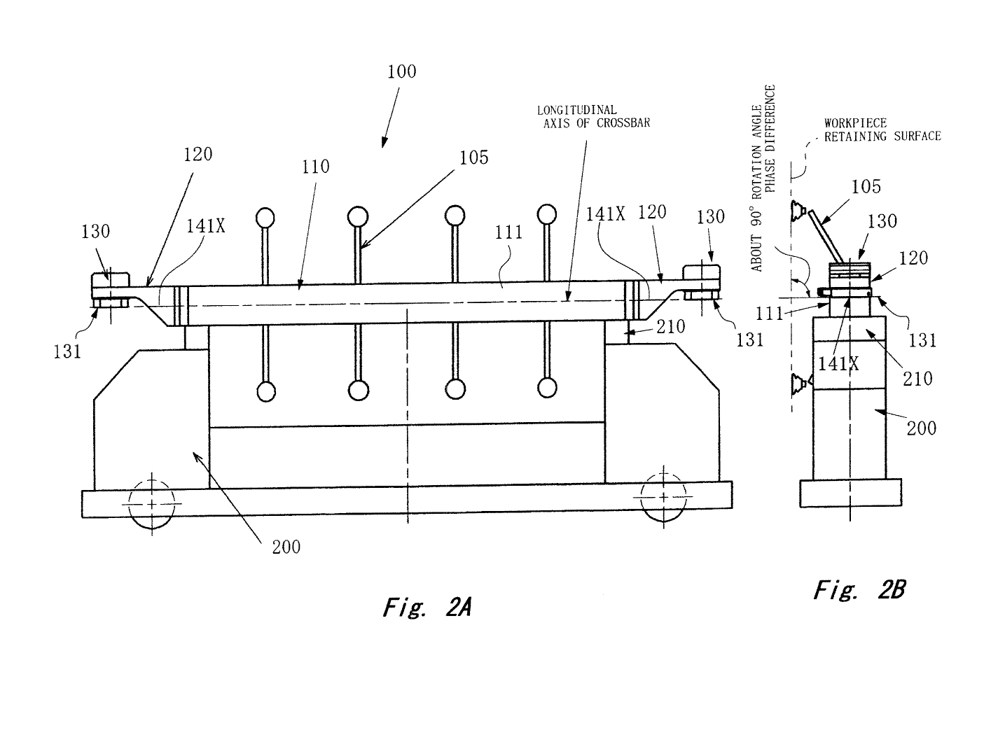

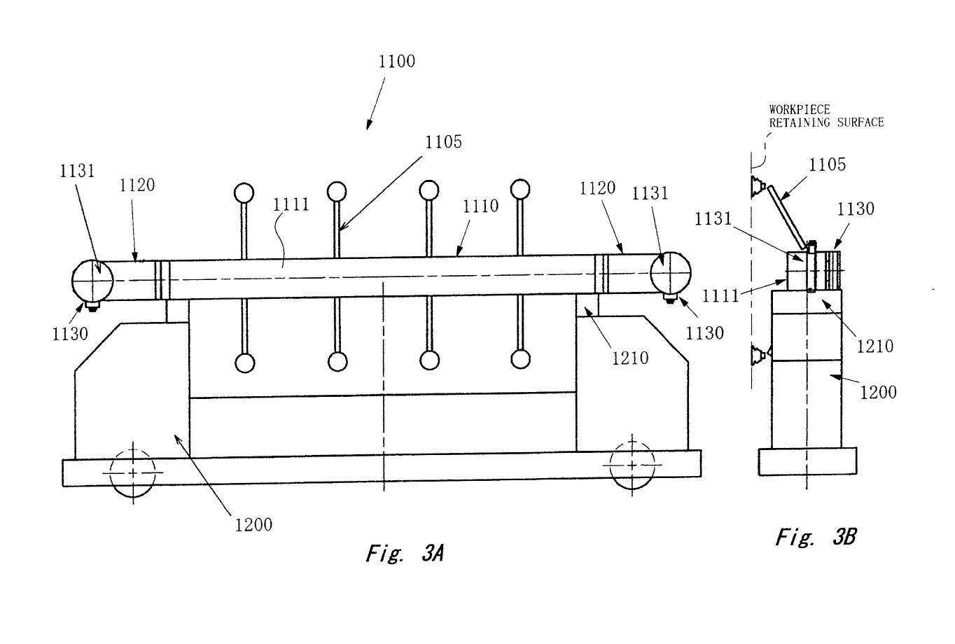

FIGS. 2A, 2B, 3A, and 3B illustrate a situation where the crossbar 100 is stacked on the crossbar replacing apparatus 200.

FIG. 2A is a view as seen from a workpiece transferring direction, which illustrates the crossbar replacing apparatus in a state in which the crossbar according to this embodiment is stacked, and FIG. 2B is a side view of FIG. 2A (view as seen from the lateral side in the workpiece transferring direction).

FIG. 3A is a view as seen from the workpiece transferring direction, which illustrates the crossbar replacing apparatus in a state in which a crossbar in a conventional apparatus is stacked, and FIG. 3B is a side view of FIG. 3A (view as seen from the lateral side in the workpiece transferring direction).

The crossbar replacing apparatus 200 can stack one or a plurality of crossbars 100. The workpiece transferring apparatus 300 can, as necessary, stack the crossbar 100 onto the crossbar replacing apparatus 200 or receive the crossbar 100 from the crossbar replacing apparatus 200 having the crossbar 100 stacked thereon.

In this case, in order to simplify the description, the crossbar 100 that is transformed from a state of being mounted to the workpiece transferring apparatus 300 as illustrated in FIG. 1 to a state of being stacked onto the crossbar replacing apparatus 200 as illustrated in FIGS. 2A, 2B, 3A, and 3B is referred to as “crossbar 100A for current production” (crossbar 100A that has been used for current production).

Further, the crossbar 100 that is transformed from a state of being stacked onto the crossbar replacing apparatus 200 as illustrated in FIGS. 2A, 2B, 3A, and 3B to a state of being mounted to the workpiece transferring apparatus 300 as illustrated in FIG. 1 is referred to as “crossbar 100B for subsequent production” (crossbar 100B to be used for subsequent production).

FIGS. 2A and 2B illustrate a situation in this embodiment, in which the crossbar 100B for subsequent production is stacked onto the crossbar replacing apparatus 200 while maintaining an angle phase difference of about 90° (rotation angle phase difference: in this case, substantially orthogonal) between a center portion 110 (lower surface 111 of the center portion 110, by extension, the workpiece retaining surface) and each of both the end portions 120 (fitting surfaces 131) of the crossbar 100B for subsequent production. Note that, the lower surface 111 of the center portion 110 and the workpiece retaining surface are substantially parallel to each other.

FIGS. 3A and 3B relate to a conventional device, and illustrate a situation where the crossbar 1003 for subsequent production is stacked onto the crossbar replacing apparatus 1200 while maintaining the same phase (substantially parallel) between a center portion 1110 (lower surface 1111 of the center portion 1110, by extension, the workpiece retaining surface) and each of both the end portions 1120 (fitting surfaces 1131) of the crossbar 100B for subsequent production.

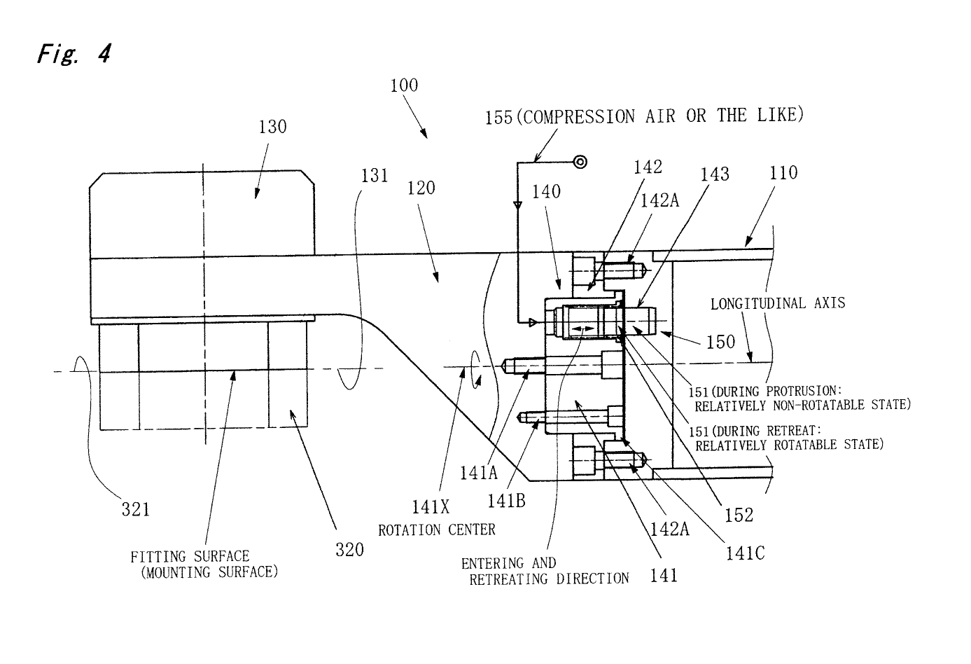

FIG. 4 illustrates an example of a case where a rotation mechanism 140 including a free rotation shaft 141 and a rotation fixing mechanism 150 for fixing the rotation, which are necessary for realizing the system and method of replacing a crossbar according to this embodiment, are provided between the center portion 110 and each of both the end portions 120 of the crossbar 100. FIG. 4 illustrates only one of the pair of both the end portions 120.

The free rotation shaft 141 is connected and fixed to each of both the end portions 120 of the crossbar 100 through intermediation of fixation bolts 141A and 141B or the like.

On the other hand, a rotation bearing portion 142 for rotatably receiving and supporting an outer peripheral part of the free rotation shaft 141 except for a flange portion 1410 is connected and fixed to the center portion 110 of the crossbar 100 through intermediation of fixation bolts 192A.

With this configuration, each of both the end portions 120 of the crossbar 100 is configured so as to be rotatable relative to the center portion 110 about a rotation center axis 141X.

Then, the rotation fixing mechanism 150 causes a pin 151 that is elastically biased on the left side by a spring 152 in FIG. 4 to move on the right side by pushing the pin 151 against an elastic biasing force of the spring 152 with compressed air 155. In this manner, the pin 151 engages with an engagement hole 143 provided in the center portion 110 of the crossbar 100. Thus, rotation of the free rotation shaft 141 relative to the rotation bearing portion 142 (rotation of both the end portions 120 of the crossbar 100 relative to the center portion 110) can be fixed.

Note that, by releasing the compressed air 155, the pin 151 is elastically biased by the spring 152 to be moved on the left side in FIG. 4. In this manner, the engagement with the engagement hole 143 is released to enable rotation of the free rotation shaft 141 relative to the rotation bearing portion 142 (rotation of both the end portions 120 of the crossbar 100 relative to the center portion 110).

With this, as for both the end portions 120 and the center portion 110 of the crossbar 100, as necessary, both the end portions 120 can freely rotate with respect to the center portion 110, or the rotation can be fixed. That is, the crossbar 100 is configured to be switchable between a state in which both the end portions 120 are rotatable relative to the center portion 110 about a longitudinal axis of the crossbar (relative rotation free state), and a state in which both the end portions 120 are not rotatable relative to the center portion 110 (relative rotation fixing state).

Further, when both the end portions 120 are freely rotatable with respect to the center portion 110, with tilting functions (rotational drive portions) 315 of the workpiece transferring apparatus 300, merely both the end portions 120 of the crossbar 100 can be rotated (both the end portions 120 of the crossbar 100 can be rotated relative to the center portion 110). When the rotation of both the end portions 120 with respect to the center portion 110 is fixed, with the tilting functions (rotational drive portions) 315 of the workpiece transferring apparatus 300, the entire crossbar 100 including both the end portions 120 and the center portion 110 can be tilted (rotated).

FIG. 4 represents merely an example, and as long as the rotation mechanism and the rotation fixing mechanism are provided, the structure is not limited to that illustrated in FIG. 4. For example, a clutch mechanism (friction clutch mechanism, electromagnetic clutch mechanism, and the like) can be used.

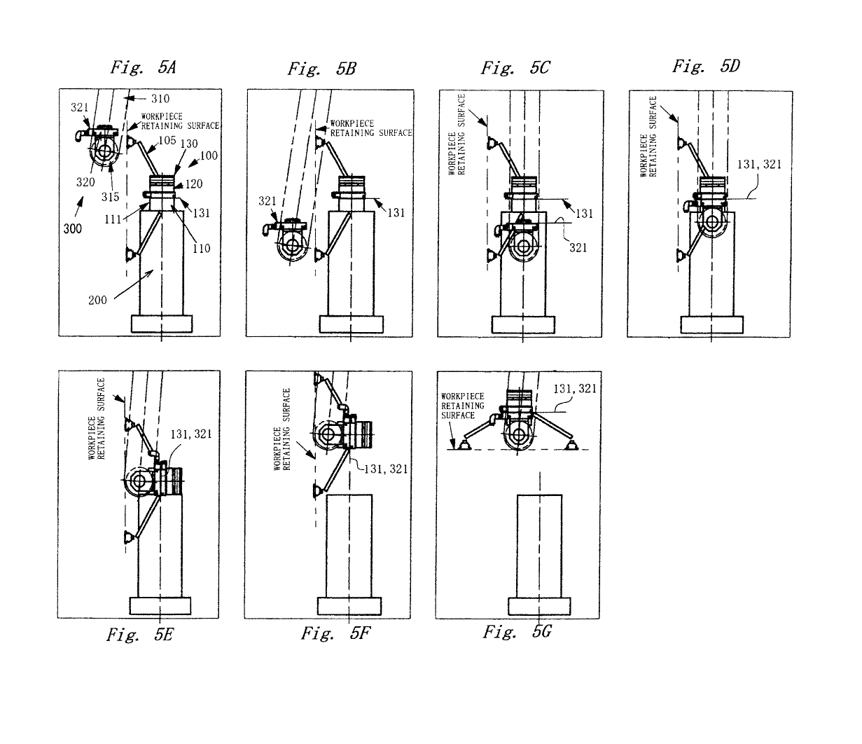

FIGS. 5A to 5G illustrate a method of replacing (situation of replacing) the crossbar 100 according to this embodiment.

FIGS. 5A to 5G illustrate, in the order of FIGS. 5A, 5B, 5C, 5D, 5E, 5F, and 5G, a situation of an operation of mounting the crossbar 100B for subsequent production to the workpiece transferring apparatus 300, and removing the crossbar 100B for subsequent production from the crossbar replacing apparatus 200.

Further, FIGS. 5A to 5G illustrate, in the order of FIGS. 5G, 5F, 5E, 5D, 5C, 5B, and 5A, a situation of an operation in which, after the workpiece transferring apparatus 300 having the crossbar 100A for current production mounted thereon sets (places) the crossbar 100A for current production on an empty crossbar replacing apparatus 200 supporting nothing, the workpiece transferring apparatus 300 moves toward another crossbar replacing apparatus 200 to pick up the crossbar 100B for subsequent production.

Now, the method of replacing the crossbar 100 according to this embodiment is described with reference to FIGS. 5A to 5G.

First, description is made of an operation method when the workpiece transferring apparatus 300 stacks the crossbar 100A for current production onto the crossbar replacing apparatus 200 (in the order of FIGS. 5G, 5F, 5E, 5D, 5C, 5B, and 5A).

In Step 1, the workpiece transferring apparatus 300 tilts, through intermediation of the tilting mechanisms (rotational drive portions) 315 provided on the leading ends of swing arms 310, the entire crossbar 100A for current production (under a state in which rotation of both the end portions 120 with respect to the center portion 110 is fixed by the rotation fixing mechanisms 150) by about 90° with respect to the vertical direction (operation from FIG. 5G to FIG. 5F).

In Step 2, while maintaining the attitude tilted by 90°, the crossbar 100A for current production is lowered on the upper surface of the crossbar replacing apparatus 200, to thereby stack and fix the crossbar 100A for current production thereon (operation from FIG. 5F to FIG. 5E).

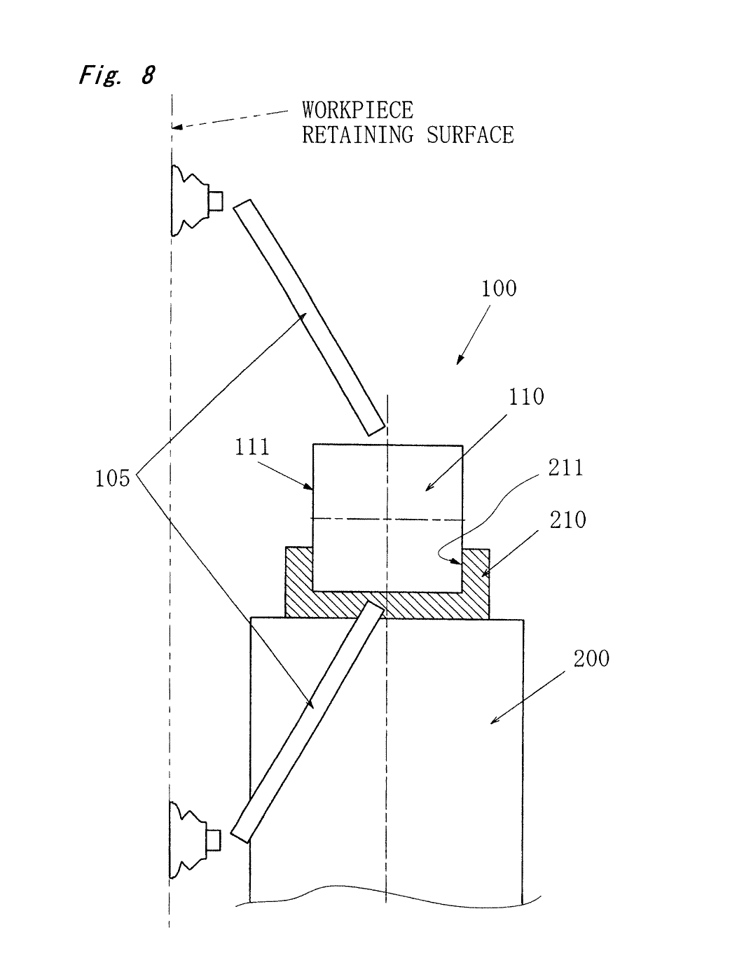

Note that, as illustrated in FIG. 8 described later, the crossbar 100A for current production is placed on a crossbar tray 210 for fixing the rotation of the center portion 110 of the crossbar 100A for current production.

In Step 3, the fixation by the rotation fixing mechanisms 150 is released so as to enable free rotation of both the end portions 120 of the crossbar 100A for current production.

In Step 4, with use of the drive of the tilting mechanisms (rotational drive portions) 315 of the workpiece transferring apparatus 300 or the like, merely both the end portions 120 of the crossbar 100A for current production are rotated by 90° via the rotation mechanisms 140 to achieve the horizontal attitude (to horizontally set the fitting surfaces 131). At this time, the rotation of the center portion 110 (lower surface 111 of the center portion 110) of the crossbar 100A for current production, which is supported by the crossbar tray 210 as illustrated in FIG. 8 described later, is fixed, and hence the crossbar 100A for current production is kept tilted by 90° (kept erected vertically) as in the original state (operation from FIG. 5E to FIG. 5D).

In Step 5, the swing arms 310 of the workpiece transferring apparatus 300 are extended, and the crossbar mounting and removing portions 320 mounted to the tilting mechanisms (rotational drive portions) 315 at the leading ends of the swing arms 310 are separated from mounting and removing devices 130 (fitting surfaces 131) in a vertically downward direction (operation from FIG. 5D to FIG. 5C).

Next, description is made of an operation method when the crossbar 100B for subsequent production is mounted on the workpiece transferring apparatus 300 to be removed from the crossbar replacing apparatus (in the order of FIGS. 5A, 5B, 5C, 5D, 5E, 5F, and 5G).

In Step 11, under a state in which no crossbar is mounted on the workpiece transferring apparatus 300, while keeping such a horizontal attitude that crossbar fitting surfaces 321 of the crossbar mounting and removing portions 320 at the leading ends of the swing arms 310 are maintained to be horizontal, the workpiece transferring apparatus 300 is brought into close contact with, from the vertically downward direction, the fitting surfaces 131 of the mounting and removing devices 130 provided at both the end portions 120 of the crossbar 100B for subsequent production placed on the crossbar replacing apparatus 200, to thereby mount the crossbar 100B for subsequent production thereon (operation from FIG. 5C to FIG. 5D).

In Step 12, with use of the drive of the tilting mechanisms (rotational drive portions) 315 of the workpiece transferring apparatus 300 or the like, merely both the end portions 120 of the crossbar 100B for subsequent production are rotated by 90° with respect to the vertical direction via the rotation mechanisms 140 so that the center portion 110 and both the end portions 120 of the crossbar 100B for subsequent production have attitudes oriented in the same direction without any angle phase difference (operation from FIG. 5D to FIG. 5E). That is, there is established a state in which the fitting surfaces 131 and the crossbar fitting surfaces 321 become substantially parallel to the lower surface 111 of the center portion 110 (workpiece retaining surface) (vertically erected state).

In Step 13, the rotation mechanisms 140 are fixed by the rotation fixing mechanisms 150 to fix the center portion 110 to both the end portions 120 of the crossbar 100B for subsequent production so that relative rotation is disabled.

In Step 14, while maintaining the attitude tilted by 90°, the crossbar 100B for subsequent production is lifted in the vertically upward direction, to thereby remove the crossbar 1005 for subsequent production from the crossbar replacing apparatus 200 (operation from FIG. 5E to FIG. 5F).

In subsequent Step 15, with use of the drive of the tilting mechanisms (rotational drive portions) 315 of the workpiece transferring apparatus 300 or the like, the entire crossbar 100B for subsequent production is rotated by 90° so that the lower surface 111 of the center portion 110 of the crossbar 100B for subsequent production and the workpiece retaining surface become substantially horizontal (oriented downward) to prepare for workpiece transfer (operation from FIG. 5F to FIG. 5G).

In this embodiment, the operation is performed as described above, and hence the workpiece transferring apparatus 300 is prevented from mounting and removing the crossbar 100 in the horizontal direction.

That is, as described in FIGS. 5A to 5G, in this embodiment, when the crossbar 100 is mounted to and removed from the workpiece transferring apparatus 300, unlike the conventional case, a horizontal operation of moving the workpiece transferring apparatus 300 in the horizontal direction for close contact while erecting the crossbar fitting surfaces 321 of the crossbar mounting and removing portions 320 substantially vertically is unnecessary. As illustrated in FIGS. 5C and 5D, the crossbar mounting and removing portions 320 can be mounted and removed from the vertically downward direction while maintaining the crossbar fitting surfaces 321 substantially horizontal.

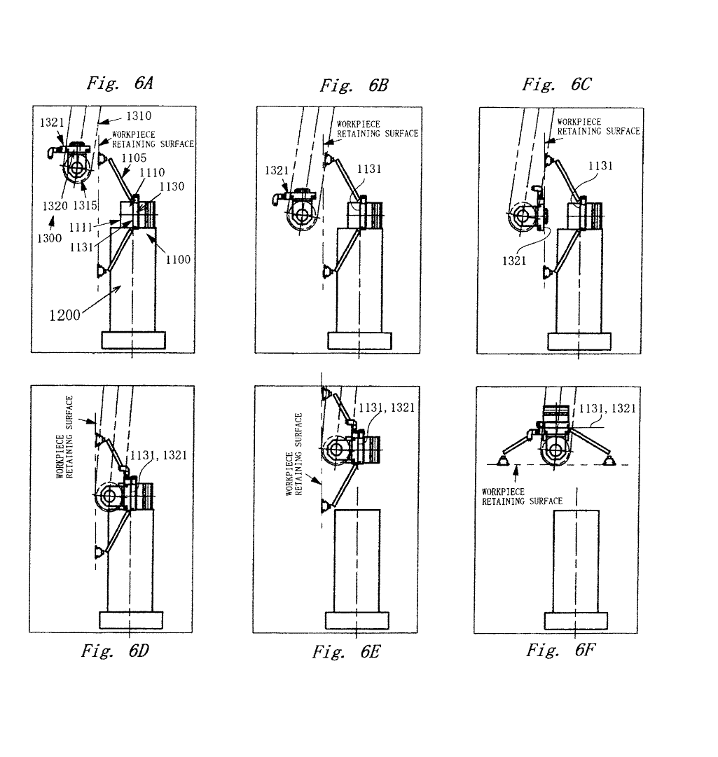

On the other hand, in the conventional technology, as described above, when the crossbar 1100 is mounted to or removed from the workpiece transferring apparatus 1300, as illustrated in FIGS. 6C and 6D, the horizontal operation of moving the workpiece transferring apparatus 1300 in the horizontal direction for close contact while erecting the crossbar fitting surfaces 1321 of the crossbar mounting and removing portions 1320 substantially vertically is necessary.

Therefore, as is understood through comparison between FIGS. 5A to 5G and FIGS. 6A to 6F, according to the method of replacing the crossbar according to this embodiment, as illustrated in FIGS. 5A to 5G, when replacing the crossbar, it is possible to prevent the workpiece transferring apparatus from mounting and removing the crossbar in the substantially horizontal direction. That is, it is possible to prevent the workpiece transferring apparatus 1300 from performing an operation having difficulty in operation control and operation adjustment, such as an operation of moving the workpiece transferring apparatus 1300 in the horizontal direction while vertically erecting the crossbar fitting surfaces 1321 of the crossbar mounting and removing portions 1320.

Further, according to this embodiment, the following effect is also produced. That is, during operation adjustment (setup), the tilting angles of the mounting and removing devices on the workpiece transferring apparatus side and on the crossbar side need not be adjusted.

As described above, according to this embodiment, even with a relatively simple and low-cost configuration, the crossbar supported by the workpiece transferring apparatus can be promptly and smoothly mounted and removed and replaced between the workpiece transferring apparatus and the crossbar replacing apparatus. Thus, the setup operation time period can be reduced to improve the production efficiency or the like.

Note that, in this embodiment, description is made, as an example, a case where, while the fitting surfaces 131 of the mounting and removing devices 130 provided at both the end portions 120 of the crossbar 100 are in the horizontal attitude, the lower surface 111 of the center portion 110 of the crossbar 100 has an angle phase difference of about 90°. However, the angle phase difference is not limited to 90°, and the present invention is widely applicable to cases of other angle phase differences as well.

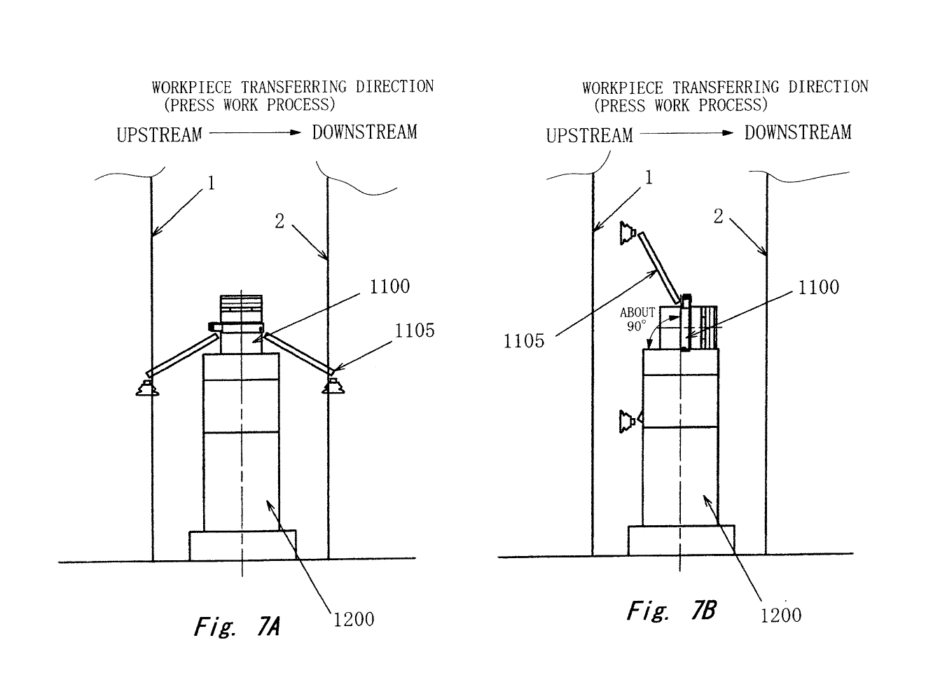

FIGS. 7A and 7B illustrate a situation where the crossbar replacing apparatus travels (moves) between the press machines installed on the upstream and the downstream in the press work process.

In this case, as illustrated in FIG. 7A, when the tool 1105 is in the same horizontal attitude state as that during production, the tool 1105 interferes with the press machines 1 and 2. Therefore, as illustrated in FIG. 7B, the tool 1105 is tilted (in FIG. 7B, an angle phase difference of 90° with respect to FIG. 7A), and thus the interference is avoided.

FIG. 8 illustrates a situation where, according to this embodiment, as an example of a method of installing the crossbar Into the crossbar replacing apparatus 200, the crossbar replacing apparatus 200 includes the crossbar tray 210 for fixing the rotation of the crossbar 100.

A recessed portion 211 of the crossbar tray 210 receives the center portion 110 of the crossbar 100 so as to restrict the rotation about the longitudinal axis thereof. In this manner, the workpiece transferring apparatus 300 can rotate merely the both the end portions 120 of the crossbar 100 (rotate both the end portions 120 of the crossbar 100 relative to the center portion 110) by the rotational drive of the tilting mechanisms (rotational drive portions) 315 of the workpiece transferring apparatus 300.

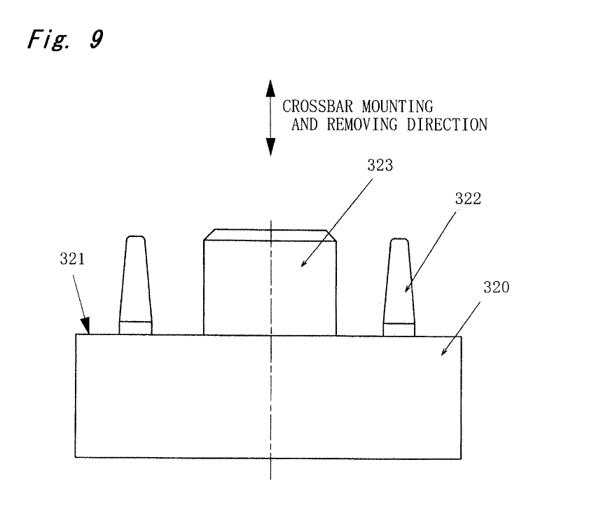

FIG. 9 illustrates an example of the crossbar mounting and removing portion 320 of the workpiece transferring apparatus 300, which is mounted to and removed from the mounting and removing device 130 of the crossbar 100.

The crossbar mounting and removing portion 320 (on the workpiece transferring apparatus 300 side) includes the guide pins 322 for guiding mutual positions when the mounting and removing device 130 (on the crossbar 100 side) is mounted, and a mounting and removing mechanism 323 serving as a mechanism for actually performing the mounting and removing.

In this case, the crossbar mounting and removing portion 320 is configured to be simultaneously connectable to compressed air, an electrical signal, or the like simultaneously when the mounting and removing device 130 (on the crossbar 100 side) is mounted. That is, the crossbar mounting and removing portion 320 can be configured as follows. For example, when the guide pins 322 and the mounting and removing mechanism 323 are set at predetermined positions with respect to the mounting and removing device 130, compressed air, an electrical signal, or the like may pass inside the mounting and removing mechanism 323 or the like so as to be supplied to the mounting and removing device 130 (on the crossbar 100 side).

Note that, the mounting and removing mechanism 323 can be configured as follows to enable mounting and removing of the crossbar 100. For example, an electromagnet may be used to enable mounting and removing of the crossbar 100, or an air pressure or the like may be used to increase or decrease the outer diameter to enable switching between a non-separable state and a separable state with respect to an engagement hole of the mounting and removing device 130 (on the crossbar 100 side).

As the crossbar mounting and removing portion 320, for example, a readily-accessible automatic tool changer (“Change System XC-120” manufactured by Nitta Corporation, Quick-change “QCP-100” manufactured by BL AUTOTEC, LTD., or the like) can be used.

In this case, when, as in the conventional case, the fitting surfaces 131 of the mounting and removing devices 130 of the crossbar 100 are mounted to the crossbar fitting surfaces 321 of the crossbar mounting and releasing portions 320 of the workpiece transferring apparatus 300 in a vertical attitude (vertically erected attitude), the crossbar mounting and removing portions 320 are provided with the guide pins 322 to enable smooth mounting, and the workpiece transferring apparatus 300 pushes the crossbar mounting and removing portions 320 (on the workpiece transferring apparatus 300 side) toward the mounting and removing devices 130 (on the crossbar 100 side).

In this case, when, as in the conventional case, the fitting surfaces 131 of the mounting and removing devices 130 of the crossbar 100 are mounted in the vertical attitude, in a case where the position and angle between the mounting and removing device 130 and the crossbar mounting and removing portion 320 are different, the crossbar 100 is moved by the guide pins 322. However, the crossbar 100 is a heavy good, and hence it is difficult to support the weight of the crossbar 100 and lift the crossbar 100 in a perpendicularly upward direction merely by the guide pins 322 extending in the horizontal direction. Further, the crossbar 100 cannot be moved downward any more, and hence it may be assumed a case where the guide pins 322 cannot be inserted to reach the defined positions.

Further, the pair of crossbar mounting and removing portions 320 of the workpiece transferring apparatus 300 is required to be simultaneously mounted to the respective pair of mounting and removing devices 130 provided at both the ends of the crossbar 100. Considering the mechanical and control errors, there are more than a few positional and angular errors at both the ends of the crossbar 100. Therefore, mounting in the vertical attitude as in the conventional case is extremely difficult.

On the other hand, as in this embodiment, when the fitting surfaces 131 of the mounting and removing devices 130 of the crossbar 100 (fitting surfaces 321 of the crossbar mounting and removing portions 320 of the workpiece transferring apparatus 300) are mounted in a horizontal attitude (horizontally laid attitude), even if there are positional and angular errors in the mounting and removing devices 130 of the crossbar 100, if the error amount is relatively small, the position of the crossbar 100 can be corrected by the guide pins 322, and thus the mounting and removing devices 130 of the crossbar 100 can be easily mounted.

As described above, according to this embodiment, the following configuration is obtained. Relative rotation is possible between the center portion (workpiece retaining portion) 110 and both the end portions 120 of the crossbar 100. Under a state in which, while maintaining the lower surface 111 of the center portion 110 of the crossbar 100 and the workpiece retaining surface in the substantially vertical direction, the fitting surfaces 131 of the mounting and removing devices 130 provided at both the end portions 120 of the crossbar 100 (crossbar fitting surfaces 321 of the crossbar mounting and removing portions 320 of the workpiece transferring apparatus 300) are set substantially horizontal, the crossbar 100 can be mounted to and removed from the workpiece transferring apparatus 300. In addition, at least during workpiece transfer, while maintaining the fitting surfaces 131 of the mounting and removing devices 130 provided at both the end portions 120 of the crossbar 100 (crossbar fitting surfaces 321 of the crossbar mounting and removing portions 320 of the workpiece transferring apparatus 300) substantially horizontal, the attitude is switched so that the lower surface 111 of the center portion 110 of the crossbar 100 and the workpiece retaining surface become substantially horizontal (oriented downward), and workpiece transfer is performed in this state. In this manner, it is possible to eliminate the necessity of mounting and removing the crossbar 100 under a state in which the fitting surfaces 131 of the mounting and removing devices 130 provided at both the end portions 120 of the crossbar 100 (crossbar fitting surfaces 321 of the crossbar mounting and removing portions 320 of the workpiece transferring apparatus 300) are erected substantially vertically. Thus, without difficult operation adjustment or the like, the crossbar 100 can be promptly and smoothly mounted and removed for replacement between the workpiece transferring apparatus 300 and the crossbar replacing apparatus 200.

That is, according to this embodiment, even with a relatively simple and low-cost configuration, the crossbar supported by the workpiece transferring apparatus can be promptly and smoothly mounted and removed for replacement between the workpiece transferring apparatus and the crossbar replacing apparatus. Thus, the setup operation time period can be reduced to improve the production efficiency or the like.

Further, according to this embodiment, the crossbar replacing apparatus 200 can support the crossbar 100 in a space-saving attitude with respect to the horizontal direction. Therefore, it is possible to maintain a short interval between the press machines, which can contribute to reduction of takt time and saving of the space in the press work line.

The embodiment described above is merely an example for describing the present invention, and various modifications can be made thereto without departing from the gist of the present invention.

What is claimed is:

1. A crossbar, which is to be mounted to a workpiece transferring apparatus and is configured to be capable of retaining and releasing a workpiece,
the crossbar extending substantially orthogonal to a workpiece transferring direction in a press machine,
the crossbar being configured to be switchable between a state in which both end portions of the crossbar are rotatable relative to a center portion of the crossbar about a longitudinal axis of the crossbar, and a state in which both the end portions are not rotatable relative to the center portion.

2. A system for replacing a crossbar, the system comprising:
a crossbar that extends substantially orthogonal to a workpiece transferring direction in a press machine and is configured to be capable of retaining and releasing a workpiece;
a workpiece transferring apparatus that transfers the workpiece with use of the crossbar; and
a crossbar replacing apparatus that is configured to be capable of supporting the crossbar,
the crossbar being replaced between the workpiece transferring apparatus and the crossbar replacing apparatus,
the system being configured to:
use the crossbar configured to be switchable between a state in which both end portions of the crossbar are rotatable relative to a center portion of the crossbar about a longitudinal axis of the crossbar, and a state in which both the end portions are not rotatable relative to the center portion;
apply, when the workpiece transferring apparatus is moved toward the crossbar replacing apparatus to place the crossbar thereon, a rotation angle phase difference between the center portion and each of both the end portions of the crossbar, to thereby allow the crossbar replacing apparatus to support the crossbar under a state in which a fitting surface of a mounting and removing device provided at the each of both the end portions of the crossbar, the fitting surface being removably mountable to a crossbar fitting surface of a crossbar mounting and removing portion of the workpiece transferring apparatus, is oriented in a substantially horizontal direction; and
cause, when the workpiece transferring apparatus is moved toward the crossbar replacing apparatus to pick up the crossbar therefrom, the crossbar fitting surface of the crossbar mounting and removing portion to approach the fitting surface of the mounting and removing device of the crossbar supported by the crossbar replacing apparatus under a state in which the crossbar fitting surface is oriented in the substantially horizontal direction, mount the crossbar to the workpiece transferring apparatus, and then cancel the rotation angle phase difference between the center portion and the each of both the end portions of the crossbar.

3. A system for replacing a crossbar according to claim 2, wherein the crossbar supported by the crossbar replacing apparatus has a workpiece retaining surface oriented in a substantially vertical direction.

4. A method of replacing a crossbar, which extends substantially orthogonal to a workpiece transferring direction in a press machine and is configured to be capable of retaining and releasing a workpiece, between a workpiece transferring apparatus that transfers the workpiece with use of the crossbar and a crossbar replacing apparatus that is configured to be capable of supporting the crossbar,
the method comprising:
using the crossbar configured to be switchable between a state in which both end portions of the crossbar are rotatable relative to a center portion of the crossbar about a longitudinal axis of the crossbar, and a state in which both the end portions are not rotatable relative to the center portion;
applying, when the workpiece transferring apparatus is moved toward the crossbar replacing apparatus to place the crossbar thereon, a rotation angle phase difference between the center portion and each of both the end portions of the crossbar, to thereby allow the crossbar replacing apparatus to support the crossbar under a state in which a fitting surface of a mounting and removing device provided at the each of both the end portions of the crossbar, the fitting surface being removably mountable to a crossbar fitting surface of a crossbar mounting and removing portion of the workpiece transferring apparatus, is oriented in a substantially horizontal direction; and
causing, when the workpiece transferring apparatus is moved toward the crossbar replacing apparatus to pick up the crossbar therefrom, the crossbar fitting surface of the crossbar mounting and removing portion to approach the fitting surface of the mounting and removing device of the crossbar supported by the crossbar replacing apparatus under a state in which the crossbar fitting surface is oriented in the substantially horizontal direction, mounting the crossbar to the workpiece transferring apparatus, and then canceling the rotation angle phase difference between the center portion and the each of both the end portions of the crossbar.

5. A method of replacing a crossbar according to claim 4, wherein the crossbar supported by the crossbar replacing apparatus has a workpiece retaining surface oriented in a substantially vertical direction.
